(19) United States
(12) Patent Application Publication
(10) Pub. No.: US 2018/0060219 A1
(43) Pub. Date: Mar. 1, 2018

(54) APPARATUS AND METHODOLOGY FOR SYMBOLIC EXECUTION-BASED ANALYSIS OF UNINTENDED INTERACTIONS IN A COMPUTING SYSTEM

(71) Applicant: GM Global Technology Operations LLC, Detroit, MI (US)

(72) Inventor: Ramesh Sethu, Troy, MI (US)

(21) Appl. No.: 15/254,647

(22) Filed: Sep. 1, 2016

(51) Int. Cl. G06F 11/36

(52) U.S. Cl. CPC G06F 11/3668; G06F 11/3684

(57) ABSTRACT

A system for use in analyzing software code using a symbolic-execution technique. The system includes a hardware-based processing unit, and a non-transitory computer-readable storage component including a (i) concurrency-analysis module, (ii) a lightweight-analysis module, and (iii) a heavyweight-analysis module. The concurrency-analysis module, when executed by the hardware-based processing unit receives initial code and generates a potential interference matrix using the initial code. The lightweight-analysis module, when executed by the hardware-based processing unit, generates a final interface matrix using the potential interference matrix. The heavyweight-analysis module, when executed by the hardware-based processing unit, generates one or more test cases using the potential interference matrix. Various aspects of the present technology includes a non-transitory computer-readable storage devices configured to perform any of the operations described, algorithms to perform any of the operations described, and the methods or processes including the operations performed by these systems, storage devices, and algorithms.

### TECHNICAL FIELD

The present disclosure relates generally to apparatus for analyzing computing structures and, more particularly, to a tool and methodology to automatically check for unintended interactions arising out of common memory references in software components using powerful symbolic-execution techniques.

### BACKGROUND

This section provides background information related to the present disclosure which is not necessarily prior art.

Computing systems of various types are developing in complexity to expand capabilities of linked apparatus such as vehicles of transportation, product development or analysis apparatus, manufacturing equipment, or warehouse logistics apparatus. Some of these computing systems involve hundreds or thousands of software components or sub-systems interacting in a variety of ways.

The complexity involves numerous distinct software components referencing a common memory. The systems are programmed with specific guidelines involving memory references.

Whether related to memory references, complex computing systems occasionally demonstrate unintended operations or behaviors. The unintended behaviors are often exhibited in manners, or specific situations that are not exhibited during standard system validation procedures.

Because issues usually cannot be found in standard testing, higher-level or repeated testings are required. More-thorough testings are more time consuming, costly, and still may not identify all issues.

### SUMMARY

In one aspect, the present technology relates to a system for use in analyzing software code using a symbolic-execution technique. The system includes a hardware-based processing unit, and a non-transitory computer-readable storage component.

The non-transitory computer-readable storage component includes a (i) concurrency-analysis module, (ii) a lightweight-analysis module, and (iii) a heavyweight-analysis module.

The concurrency-analysis module, when executed by the hardware-based processing unit receives initial code and generates a potential interference matrix using the initial code.

The lightweight-analysis module, when executed by the hardware-based processing unit, generates a final interface matrix using the potential interference matrix.

The heavyweight-analysis module, when executed by the hardware-based processing unit, generates one or more test cases using the potential interference matrix.

In various embodiments, the concurrency-analysis module includes (a) a concurrent-task-identification sub-module that, when executed by the hardware-based processing unit, generates output using the software code; and an interference-site-identification sub-module that, when executed by the hardware-based processing unit, generates the potential interference matrix based on the output of the concurrent-task-identification sub-module.

In some implementations, the lightweight-analysis module comprises (I) a context-condition-computation sub-module that, when executed by the hardware-based processing unit, generates first output using the potential interference matrix, (II) an asserted-interference-matrix sub-module that, when executed by the hardware-based processing unit, generates second output using the first output from the context-condition-computation sub-module; and (III) an emptiness-check sub-module that, when executed by the hardware-based processing unit, generates the final interference module using the second output from the asserted-interference-matrix sub-module.

In various embodiments, the heavyweight-analysis module includes (A) the task-model-construction sub-module that, when executed by the hardware-based processing unit, generates first output, such as a task model, using the potential interference matrix, (B) the reachability-analysis sub-module, that, when executed by the hardware-based processing unit, generates second output using the first output from the task-model-construction sub-module, and (C) the test-case-generation sub-module, that, when executed by the hardware-based processing unit, generates the test cases based on the second output from the reachability-analysis sub-module.

In various embodiments, the lightweight-analysis module, when executed by the hardware-based processing unit, provides output to the heavyweight-analysis module, and the heavyweight-analysis module, when executed, generates the test cases based on the potential interference matrix and the output from the lightweight analysis module.

In some implementations, the concurrency-analysis module, when executed by the hardware-based processing unit to generate the potential interference matrix, determines code components of the initial code that have common memory references.

Various aspects of the present technology includes a non-transitory computer-readable storage devices configured to perform any of the operations described, algorithms to perform any of the operations described, and the methods or processes including the operations performed by these systems, storage devices, and algorithms.

Other aspects of the present technology will be in part apparent and in part pointed out hereinafter.

### DESCRIPTION OF THE DRAWINGS

FIG. 1 illustrates schematically an example hardware-based computing system, according to embodiments of the present technology.

FIG. 2 shows portions of the system of FIG. 1 in more detail, emphasizing example memory components.

FIG. 3 shows interactions between the various components of FIG. 2, including with external systems.

FIG. 4 illustrates various code features, including tasks and functions, and related or linked parts thereof.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. TECHNOLOGY INTRODUCTION

The present disclosure describes, by various embodiments, apparatus and methods to address the issues above and improve computing systems and analysis thereof in various ways.

The solution involves a tool and methodology to automatically check for the referenced unintended interactions arising out of the referenced common memory references in software components.

The tools and methodologies accomplish this goal using powerful symbolic-execution techniques.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trolleys, trains, manufacturing equipment (for example, forklift), construction machines, and agricultural machinery, or of warehouse equipment, devices at the office, home appliances, personal or mobile computing devices, such as phones, wearables, plug-ins, and wireless peripherals, the like, and other.

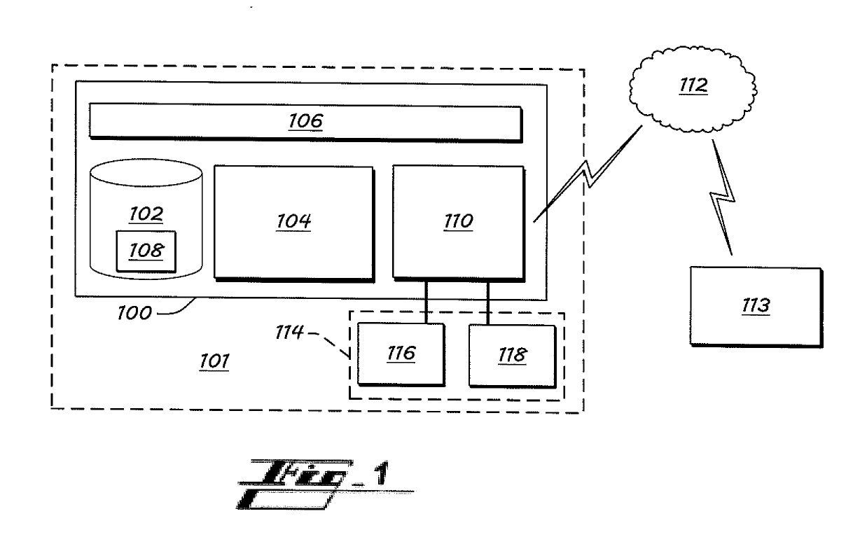

### II. HARDWARE-BASED COMPUTING SYSTEM AND BASE VEHICLE—FIG. 1

Turning now to the figures, and more particularly to the first figure, FIG. 1 shows an example hardware-based computer or computing system 100, for use in accordance with embodiments of the present disclosure.

The computer system 100 is in various embodiments part of a greater system 101, such as an automobile, server, or great computing system.

The computer system 100 can be implemented in any of a variety of ways, such as in the form of a server, within a mobile communications device, or other.

Although connections are not shown between all of the components illustrated in FIG. 1, the components can interact with each other to carry out system functions.

As shown, the computer system 100 includes a hardware-based memory, or computer-readable storage device 102, such as volatile medium, non-volatile medium, removable medium, and non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The computer system 100 also includes a processing hardware unit, or hardware-based processing unit, 104 connected or connectable to the computer-readable storage device 102 by way of a communication link 106, such as a computer bus.

The processing hardware unit can include or be multiple processors, which could include distributed processors or parallel processors in a single machine or multiple machines. The processing hardware unit can be used in supporting a virtual processing environment. The processing hardware unit could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

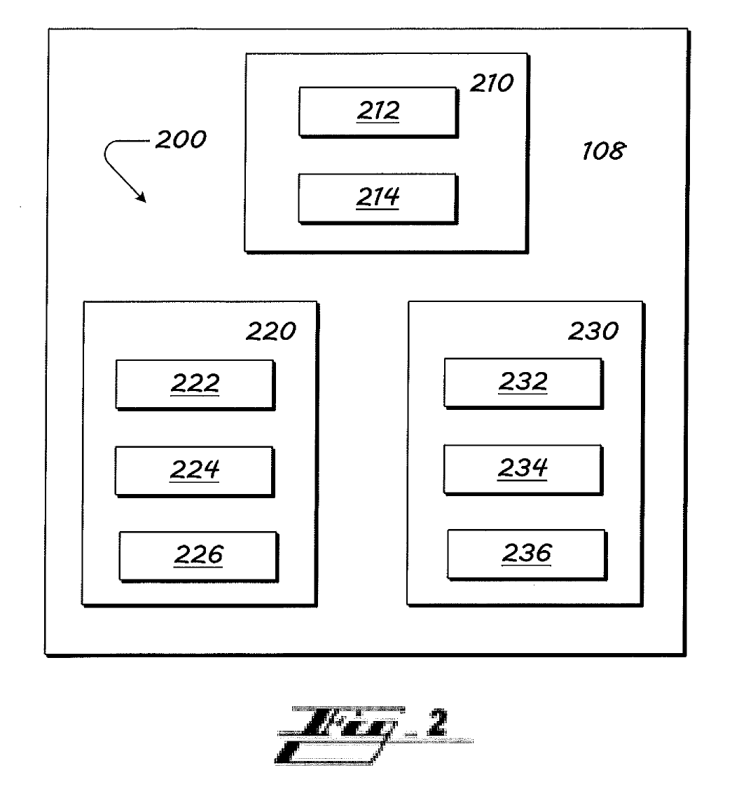

The computer-readable storage device 102 includes computer-executable instructions, or code 108, including executable modules (FIG. 2). The computer-executable instructions 108 are executable by the processing hardware unit 104 to cause the processing hardware unit, and thus the computer system 100, to perform any combination of the functions described in the present disclosure.

The computer system 100 further comprises an input/output (I/O) device 110, such as a wireless transceiver and/or a wired communication port. The processing hardware unit 104, executing the instructions 108, sends and receives information, such as in the form of messages or packetized data, to and from one or more communication networks 112, such as the Internet, and the devices they are connected to—remote servers, road-side infrastructure, other vehicles, mobile devices, etc.

In some embodiments, such as when the system 100 is implemented within a vehicle 102, the system 100 includes or is connected to one or more local input/output devices 114, including at least one local input device 116 and/or at least one local output device 118.

The inputs 116 can include vehicle sensors such as positioning system components (e.g., GPS receiver), speed sensors, and camera systems. The outputs 118 can include any automated control system of the vehicle, such as an autonomous or semi-autonomous driving system, or an HVAC system. The inputs and/or the outputs 116, 118 can include applications such as social-media, music, traffic, and weather applications installed at the vehicle 102.

By the external networks 112, such as the Internet, a local-area, cellular, or satellite network, vehicle-to-vehicle, pedestrian-to-vehicle, road-side infrastructure networks, the like or other, the computing system 100, or greater system—e.g., vehicle 101—can reach various computing apparatus 113 mobile or local systems or remote systems, such as remote servers.

Example mobile or local devices include user smartphones and a user wearable devices. Another example mobile or local device is a user plug-in device, such as a USB mass storage device, or such a device configured to communicate wirelessly.

Still another example mobile or local device is an on-board device (OBD), such as a wheel sensor, a brake sensor, an accelerometer, a rotor-wear sensor, a throttle-position sensor, a steering-angle sensor, a revolutions-per-minute (RPM) indicator, a brake-torque sensors, other vehicle state or dynamics-related sensor for the vehicle, with which the vehicle is retrofitted with after manufacture. The OBD(s) can include or be a part of a sensor sub-system or other input system, such as the inputs 116 referenced.

The computing system 100, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller are in other embodiments executed via similar or other message-based protocol.

### III. ADDITIONAL SYSTEM COMPONENTS—FIG. 2

FIG. 2 shows example memory components of the computer-readable storage device 102, and more particularly example modules 200 of the code 108 thereof.

The modules 200 are configured for performing processes of the present disclosure. Any of the code or instructions described can be part of more than one module. And any functions described herein can be performed by execution of instructions in one or more modules, though the functions may be described primarily in connection with one module by way of primary example. Each of the modules and sub-modules can be referred to by any of a variety of names, such as by a term or phrase indicative of its function.

Sub-modules can cause the processing hardware-based unit 104 to perform specific operations or routines of module functions. Each sub-module can also be referred to by any of a variety of names, such as by a term or phrase indicative of its function.

Example modules 200 and constituent sub-modules include:
Concurrency-analysis module 210
   Concurrent-task-identification sub-module 212; and
   Interference-site-identification sub-module 214;
Lightweight-interference-analysis module 220
   Context-condition-computation sub-module 222;
   Asserted-interference-matrix 224; and
   Emptiness-check sub-module 226; and
Heavyweight-interference-analysis module 230
   Task-model-construction sub-module 232;
   Reachability-analysis sub-module 234; and
   Test-case-generation sub-module 236.

The modules, sub-modules, and their functions are described more below.

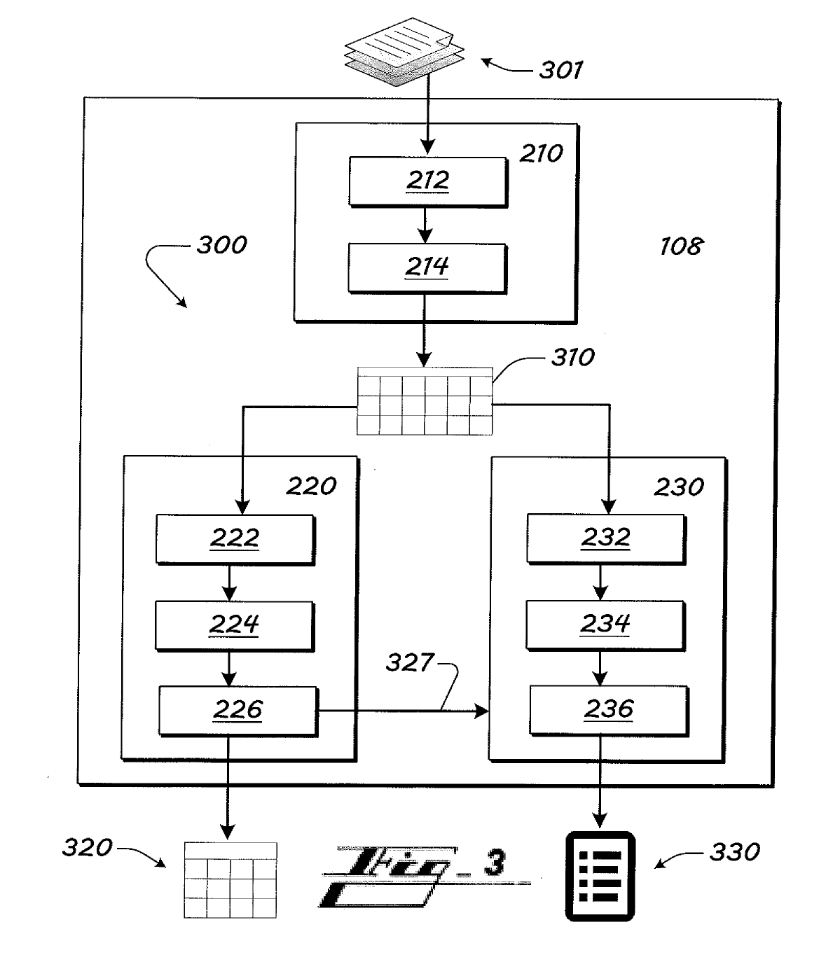

### IV. ALGORITHMS AND PROCESSES—FIG. 3

IV.A. Introduction to the Algorithms

FIG. 3 shows an example algorithm, process, or routine represented schematically by a flow 300, according to embodiments of the present technology. The algorithms, processes, and routines are at times herein referred to collectively as processes or methods for simplicity.

Though a single flow 300 is shown for simplicity, any of the functions or operations can be performed in one or more or processes, routines, or sub-routines of one or more algorithms, by one or more devices or systems.

It should be understood that the steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing unit 104, a processing unit of an user mobile, and/or the unit of a remote device, executing computer-executable instructions stored on a non-transitory computer-readable storage device of the respective device, such as the data storage device 102 of the computing system 100, which in various embodiments is a part of a greater system 101 such as an automobile or other vehicle, for instance.

IV.B. System Components and Functions

FIG. 3 shows a view components of FIG. 2 interacting according to various exemplary algorithms of the present technology. The algorithms are illustrated in the form of a process flow 300.

As provided, the performing modules 200 include the concurrency-analysis module 210. And the concurrency-analysis module 210 includes (i) the concurrent-task-identification sub-module 212 and (ii) the interference-site identification sub-module 214.

Input to the concurrency-analysis module 210 includes subject or initial computer code 301 to be analyzed. In various embodiments, the code includes description of the behavior of the code or software. The description may be provided, for example, in the form of a set of tasks. The data for each task may include (a) one or more triggers, such as events and/or time instances that will trigger execution of the task and (b) an exact sequence of functions that will be invoked during the execution. The specification of triggers and the functions can be provided in any high-level programming language or notation convention.

The initial code 301 is input to the concurrent-task-identification sub-module 212 of the concurrency-analysis module 210. The concurrent-task-identification sub-module 212, executed by the hardware-based processing unit 104, analyzes the initial code 301 to identify tasks that are configured and arranged in the initial code 301 to be performed at the same time or overlapping times or occasions in operation of the initial code 301. Depending upon the specification language/notation used, this sub-module 212 includes appropriate pre-processing units that process the code 301 using standard syntax and semantic analysis to extract the required concurrent task information.

The concurrent tasks identified by the concurrent-task-identification sub-module 212 are sent to the interference-site-identification sub-module 214. The interference-site-identification sub-module 214, executed by the hardware-based processing unit 104, analyzes code components, including the concurrent tasks identified, to identify all interferences amongst the concurrent tasks.

Interferences include concurrent tasks that are configured and arranged in the code 301 to have the same, similar, or related memory usage occurrences or patterns. Use of the data storage device 102 can include using the memory at the same time and/or using a common component of the data storage device 102. In various embodiments, concurrent tasks accessing common storage elements (in an appropriate high level language descriptions, for instance) may lead to two or more tasks reading/writing onto a common storage element. In such cases, a result of the executions may not be clearly defined, or defined differently during different execution runs of the system.

The interference-site-identification sub-module 214 outputs a potential interference matrix 310, which is also thus output of the concurrency-analysis module 210.

The interference matrix 310 is in various embodiments a table or other format of data indicating, or making available to be extracted, an exact condition or conditions under which a pair of tasks invokes a common function, or invokes a read and a write operation. A specific embodiment of this table is a series of rows and columns, with one row for each pair of tasks and one column for each common function. The entry corresponding to a row and a column can be a Boolean condition.

The interference matrix 310 is input to both the lightweight-interference-analysis module 220 and the heavyweight-interference-analysis module 230. As with all modules and submodules herein, the heavyweight-interference-analysis module 230 can be referred to by other descriptive or generic terms, such as strong interference analysis module.

At the lightweight-interference-analysis module 220, the interference matrix 310 is input to the context-condition-computation sub-module 222. The context-condition-computation sub-module 222 replaces each entry in the matrix with the Boolean conjunctions indicating the path conditions in the respective task SW modules. The path condition describes the execution condition on the common storage values under which a task would invoke the common function mentioned in the table. This path condition is computed by analyzing the task code and symbolically executing the path that leads to the common function invocation. The common function may be invoked at several places in the task and, when it is, the path condition computation is performed for each of these places and a Boolean disjunction of all the path conditions is performed.

The asserted-interference-matrix 224 in various embodiments is or includes a table or other suitable data format. The enhanced matrix 224 is an enhancement or adjusted version of the interference-matrix 310, and in place of all of the original conditions in the table 310, has the strengthened conditions computed at the context-condition-computation sub-module 222.

The emptiness-check sub-module 226 inspects each element of the asserted-interference-matrix table 224, checking to see whether each indicated corresponding condition is consistent. If a condition is consistent, then it is replaced by a Boolean equivalent condition; otherwise, the entry is made null in the table 224.

Output of the emptiness-check sub-module 226, and so of the lightweight-interference module 220, includes a final interference matrix 320. The final interference matrix 320 is a table or other suitable data format containing either all null elements or non-null conditions that describe the condition under which a pair of tasks can access the common function.

At the heavyweight-interference-analysis module 230, the interference matrix 310 and, in some cases also the initial code 301, are input to the task-model-construction sub-module 232 thereof. The task-model-construction sub-module 232 generates a task model based on the potential interference matrix 310 and the initial code. The sub-module 232 checks any non-empty entry/ies in the matrix 310, and identifies the corresponding tasks and their parts to be included in the models. The task-model-construction sub-module 232 then performs a backward slicing, to include all and only those parts required for executing these corresponding tasks. From these parts, the task-model-construction sub-module 232 builds a model of the tasks in a suitable language/notation. The specific language/notation is in various embodiments chosen using or based upon output of a reachability analysis tool or sub-module 234, referenced further below. In some embodiments, this language could be in the same language in which the task is written.

In various embodiments, any sub-module of the heavyweight-interference-analysis module 230 uses the output from one or more of the sub-modules of the lightweight-interference-analysis module 220, as indicated by arrow 327. The output is used in the process at the heavyweight-interference-analyses module 230 to generate the test cases 330. The process of generating the test cases is elaborated more below, regarding the test-case-generation sub-module 236.

Output of the task-model-construction sub-module 232 is provided to the reachability-analysis sub-module 234.

The reachability-analysis sub-module 234, with the output of the task model construction sub-module 232, computes for each entry of the interference matrix whether each corresponding pair of tasks can reach a respective state of their computation to invoke the common function. If this is so, then the analysis procedure generates inputs for reaching this state. The input is the test case for reaching this state regarding the respective task pair.

Output of the reachability-analysis sub-module 234 is provided to the test-case-generation sub-module 236.

The test-case-generation sub-module 236, using the output from the reachability-analysis sub-module 234, generates multiple test cases 330. As mentioned, each test case identifies the inputs that, when input to the initial code 301 will cause or ensure that when executed the code 301 reaches a state in which two tasks are at the same time invocating a common function.

The test cases 330 are used with the final interference matrix 320.

There may be zero, one, or more test cases generated for each non-empty entry in the interference matrix. If no test cases are generated by the analysis, all the potential interference sites were not reachable and the initial code 301 is free of unintended interactions. If there is at least one test case, then that test case provides an input which demonstrates the existence of an interference between a corresponding pair of tasks. These functions can be described as checking for unintended interactions arising out of common memory references in the software components using powerful symbolic-execution techniques.

The process 300 can end or any one or more operations of the process can be performed again.

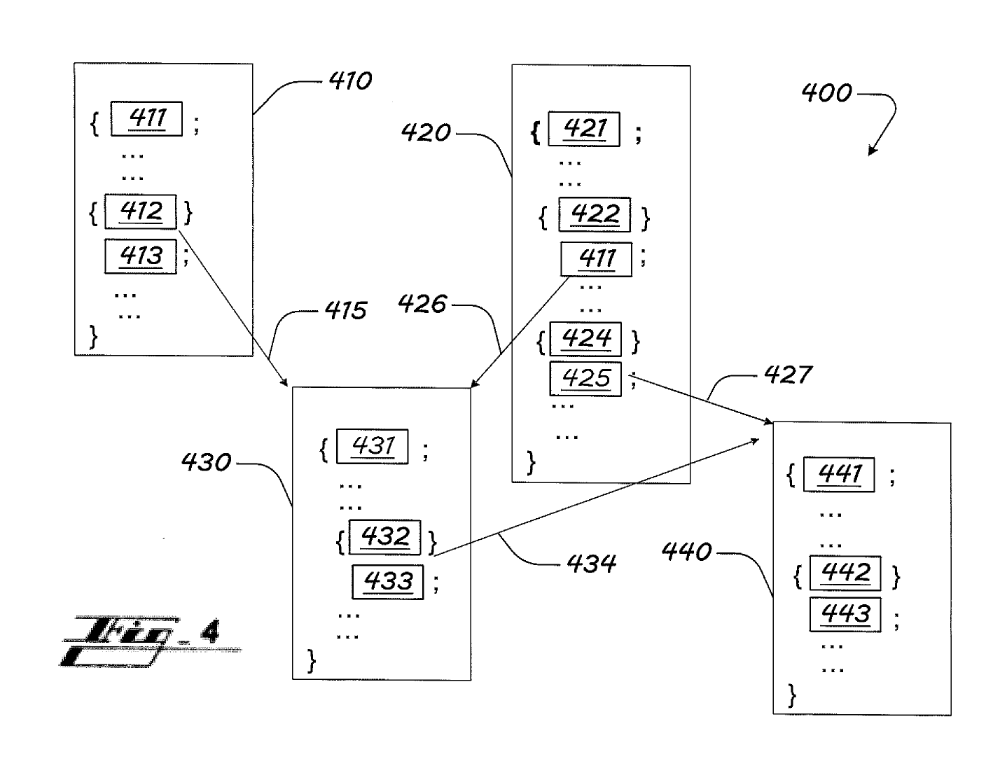

### V. EXAMPLE CODE COMPONENTS AND INTERRELATIONS—FIG. 4

FIG. 4 illustrates various code features 400.

The code features 400 include two example tasks: “Task 1” (410) and “Task 2” (420), and two example functions: “Function f” (430) and “Function g” (440).

The Tasks, Functions, and constituent parts include:

Task 1 (410)

| | |
|---|---|
| int x | (411) |
| . . . | |
| {cc1f} | (412) |
| call f( ) | (413) |
| . . . | |

Task 2 (420)

| | |
|---|---|
| real z | (421) |
| . . . | |
| {cc2f} | (422) |
| call f( ) | (423) |
| . . . | |
| {cc2g} | (422) |
| call g( ) | (423) |
| . . . | |

Function f (430)

| | |
|---|---|
| decl | (431) |
| . . . | |
| {ccf} | (432) |
| call g( ) | (433) |
| . . . | |

Function g (440)

| | |
|---|---|
| decl | (441) |
| . . . | |
| {ccg} | (442) |
| call g( ) | (443) |
| . . . | |

Relationships amongst code components can be seen by FIG. 4 and the supporting information. For instance, it can be seen that Task 1 (410) includes a part, {cc1f} (412) that calls on (arrow 415) Function f (430) via its call f( ) (413) mapping.

Another relationship amongst code components includes Task 2 (420) having a part, {cc2f} (422) that also calls on (arrow 426) Function f (430) via its call f( ) (423) mapping.

Another relationship amongst code components includes Task 2 (220) also having a part, {cc2g} (424) that also calls on (arrow 427) Function f (430) via its call f( ) (425) mapping.

Functions can also call on other functions. for instance, as shown,

Function f (430) has a part, {ccf} (432) that also calls on (arrow 434) Function g (440) via its call g( ) (433) mapping.

Regarding common memory references, it can be seen, for example, that both cc1f (412) of Task 1 (410) and cc2f (422) of Task 2 (420) refer to Function f (430). As another example of common memory referencing, both cc2g (424) of Task 2 (420) and ccf (432) of Function f (430) refer to Function g (440).

Regarding abbreviations, here:
decl. represents a set of declarations in the initial code 301;
call represents a function invocation command.

The assertions provided by {curly brackets} represent various example conditions that hold when the program control reaches that point.

Of the following two tables, Table 1 contains example conditions for a given example initial code 301. Table 2 shows a more specific data from an actual automotive implementation.

The first table below shows example interferences in tabular form including Task 1 (T1), Task 2 (T2), Function f (f) and Function g (g):

TABLE 1

| Functions vs. Tasks | F | G |
|---|---|---|
| T1, T2 | cc1f & cc2f | Ccf & cc2g |

The following, second table shows a greater sample interferences in tabular form:

TABLE 2

| Functions | Process | Process | Process | Process | Dtrmn | chartstep_ |
|---|---|---|---|---|---|---|
| vs. | XXXR_6p25ms_ | XXXR_ | XXXR_ | XXXR_ | XXXR_k_ | c3_XXXR_ |
| Tasks | Func2 | 25ms_Func | 25ms_Func2 | 25ms_Func3 | Value( ) | ReentrancyTes( ) |
| T0, T3.125 | | | | | | |
| T0, T6.25 | !GetEPSR_b_ | | | | | |
| | EngMvmtDetected( ) | | | | | |
| T0, T25 | | | | | | |
| T3.125, T6.25 | | | | | | |
| T3.125, T25 | | True | | True | True | |
| T6.25, T25 | | | True | | | True |

In Table 2:
the term True, in the chart, represents for the condition that unconditionally the control can reach this place;
T3.125 and T2.25 are sample task names. XXXXR and Reentrancy are also part of example function names; and
!GetEPSR_b_EngMvmtDetected( )” is an example condition.

### VI. SELECT ADVANTAGES

Many of the benefits and advantages of the present technology are described above. The present section restates some of those and references some others. The benefits described are not exhaustive of the benefits of the present technology.

The automated analysis of software components provided by the present technology relieves modeling and software-development teams from performing laborious and time consuming manual inspections of the software components.

The automated analysis of the present technology is accurate and reduces required validation cycle time for such software and any electronic subsystems including the software. The accuracy enhances the quality of relate products—e.g., vehicle software analyzed.

From a business perspective, productivity in product development is increased as a result of the automated validation of the present technology.

Reduction of these problems caused by software, especially in the context of increased software in today's and future vehicles, will enhance the quality and confidence of vehicle-users, or users of any product incorporating the subject software.

The present technology is in some embodiments configured to allow any supporting personnel—modelers, system engineers, etc.—to initiate performance of the automated analysis by a simple selection, e.g., mouse or button click. This saves much time compared to conventional manual evaluation required.

The resulting software thus has a very high quality, and is obtained by less integration testing than conventionally needed.

Complex field failures typically arising out of complex software and integration options are reduced if not completely avoided.

The unintended interactions caused by conventional code are avoided.

### VII. CONCLUSION

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for use in analyzing software code using a symbolic-execution technique, comprising:
a hardware-based processing unit; and
a non-transitory computer-readable storage component comprising:
a concurrency-analysis module that, when executed by the hardware-based processing unit:
receives initial code; and
generate, using the initial code, a potential interference matrix;
a lightweight-analysis module that, when executed by the hardware-based processing unit, generates, using the potential interference matrix, a final interface matrix; and
a heavyweight-analysis module that, when executed by the hardware-based processing unit, generates, using the potential interference matrix, one or more test cases.

2. The system of claim 1 wherein the concurrency-analysis module comprises:
a concurrent-task-identification sub-module that, when executed by the hardware-based processing unit, generates output using the software code; and
an interference-site-identification sub-module that, when executed by the hardware-based processing unit, generates the potential interference matrix based on the output of the concurrent-task-identification sub-module.

3. The system of claim 1 wherein the lightweight-analysis module comprises:
a context-condition-computation sub-module that, when executed by the hardware-based processing unit, generates first output using the potential interference matrix;
an asserted-interference-matrix sub-module that, when executed by the hardware-based processing unit, generates second output using the first output from the context-condition-computation sub-module; and
an emptiness-check sub-module that, when executed by the hardware-based processing unit, generates the final interference module using the second output from the asserted-interference-matrix sub-module.

4. The system of claim 1 wherein the heavyweight-analysis module comprises:
the task-model-construction sub-module that, when executed by the hardware-based processing unit, generates first output using the potential interference matrix;
the reachability-analysis sub-module, that, when executed by the hardware-based processing unit, generates second output using the first output from the task-model-construction sub-module; and
the test-case-generation sub-module, that, when executed by the hardware-based processing unit, generates the test cases based on the second output from the reachability-analysis sub-module.

5. The system of claim 4 wherein the first output includes a task model.

6. The system of claim 1 wherein:
the lightweight-analysis module, when executed by the hardware-based processing unit, provides output to the heavyweight-analysis module; and
the heavyweight-analysis module, when executed, generates the test cases based on the potential interference matrix and the output from the lightweight analysis module.

7. The system of claim 1 wherein the concurrency-analysis module, when executed by the hardware-based processing unit to generate the potential interference matrix, determines code components of the initial code that have common memory references.

8. A non-transitory computer-readable storage device, for use in analyzing software code using a symbolic-execution technique, comprising:
a concurrency-analysis module that, when executed by a hardware-based processing unit:
receives initial code; and
generate, using the initial code, a potential interference matrix;
a lightweight-analysis module that, when executed by the hardware-based processing unit, generates, using the potential interference matrix, a final interface matrix; and
a heavyweight-analysis module that, when executed by the hardware-based processing unit, generates, using the potential interference matrix, one or more test cases.

9. The non-transitory computer-readable storage device of claim 8 wherein the concurrency-analysis module comprises:
a concurrent-task-identification sub-module that, when executed by the hardware-based processing unit, generates output using the software code; and
an interference-site-identification sub-module that, when executed by the hardware-based processing unit, generates the potential interference matrix based on the output of the concurrent-task-identification sub-module.

10. The non-transitory computer-readable storage device of claim 8 wherein the lightweight-analysis module comprises:
a context-condition-computation sub-module that, when executed by the hardware-based processing unit, generates first output using the potential interference matrix;
an asserted-interference-matrix sub-module that, when executed by the hardware-based processing unit, generates second output using the first output from the context-condition-computation sub-module; and
an emptiness-check sub-module that, when executed by the hardware-based processing unit, generates the final interference module using the second output from the asserted-interference-matrix sub-module.

11. The non-transitory computer-readable storage device of claim 8 wherein the heavyweight-analysis module comprises:
the task-model-construction sub-module that, when executed by the hardware-based processing unit, generates first output using the potential interference matrix;
the reachability-analysis sub-module, that, when executed by the hardware-based processing unit, generates second output using the first output from the task-model-construction sub-module; and
the test-case-generation sub-module, that, when executed by the hardware-based processing unit, generates the test cases based on the second output from the reachability-analysis sub-module.

12. The non-transitory computer-readable storage device of claim 11 wherein the first output includes a task model.

13. The non-transitory computer-readable storage device of claim 8 wherein:
the lightweight-analysis module, when executed by the hardware-based processing unit, provides output to the heavyweight-analysis module; and
the heavyweight-analysis module, when executed, generates the test cases based on the potential interference matrix and the output from the lightweight analysis module.

14. The non-transitory computer-readable storage device of claim 8 wherein the concurrency-analysis module, when executed by the hardware-based processing unit to generate the potential interference matrix, determines code components of the initial code that have common memory references.

15. A method, for use in analyzing software code using a symbolic-execution technique, comprising:
receiving, by a concurrency-analysis module executed by a hardware-based processing unit, initial code;
generating, by the concurrency-analysis module executed by the hardware-based processing unit, using the initial code, a potential interference matrix;
generating, by a lightweight-analysis module executed by the hardware-based processing unit, using the potential interference matrix, a final interface matrix; and
generating, by a heavyweight-analysis module executed by the hardware-based processing unit, using the potential interference matrix, one or more test cases.

16. The method of claim 15 wherein the concurrency-analysis module comprises:
a concurrent-task-identification sub-module that, when executed by the hardware-based processing unit, generates output using the software code; and
an interference-site-identification sub-module that, when executed by the hardware-based processing unit, generates the potential interference matrix based on the output of the concurrent-task-identification sub-module.

17. The method of claim 15 wherein the lightweight-analysis module comprises:
a context-condition-computation sub-module that, when executed by the hardware-based processing unit, generates first output using the potential interference matrix;
an asserted-interference-matrix sub-module that, when executed by the hardware-based processing unit, generates second output using the first output from the context-condition-computation sub-module; and
an emptiness-check sub-module that, when executed by the hardware-based processing unit, generates the final interference module using the second output from the asserted-interference-matrix sub-module.

18. The method of claim 15 wherein the heavyweight-analysis module comprises:
the task-model-construction sub-module that, when executed by the hardware-based processing unit, generates first output using the potential interference matrix, the first output comprising a task model;
the reachability-analysis sub-module, that, when executed by the hardware-based processing unit, generates second output using the first output from the task-model-construction sub-module; and
the test-case-generation sub-module, that, when executed by the hardware-based processing unit, generates the test cases based on the second output from the reachability-analysis sub-module.

19. The method of claim 15 wherein:
the lightweight-analysis module, when executed by the hardware-based processing unit, provides output to the heavyweight-analysis module; and
the heavyweight-analysis module, when executed, generates the test cases based on the potential interference matrix and the output from the lightweight analysis module.

20. The method of claim 15 wherein the concurrency-analysis module, when executed by the hardware-based processing unit to generate the potential interference matrix, determines code components of the initial code that have common memory references.
